(19) United States
(12) Patent Application Publication
(10) Pub. No.: US 2012/0090616 A1
(43) Pub. Date: Apr. 19, 2012

(54) Flexible Scent-Restraining Containment Mask

(76) Inventor: Robert Hanbury Means, Evergreen, CO (US)

(21) Appl. No.: 12/904,249

(22) Filed: Oct. 14, 2010

(51) Int. Cl. A62B 18/08

(52) U.S. Cl. 128/206.19

(57) ABSTRACT

A mask placeable over the nose and mouth of a user for blocking out unpleasant odors. The mask has an air-permeable body with an inner surface shaped to fit over the nose and mouth and a strap for securing the mask in place over the user's face. An arrangement of pliable material is affixed to the inner surface of the mask at nostril level providing a method to secure a separate scent emitting object at the user's discretion.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application relates to a mask which covers the nose and mouth of the wearer and conceals a pliable restraining fastener to hold a scent emitting object to effectively block unpleasant odors.

2. Prior Art

Previously, face masks designed to block unpleasant odors have been disposable, relegated to a predetermined, premanufactured scent and lacking any characteristics by which an observer of someone wearing said mask might find the mask entertaining.

Several face masks have been previously invented that address dealing with unpleasant odors. U.S. Pat. No. 4,503,851 to Braunroth (1985) uses an envelope with a mass of absorbent material which is saturated with an odor masking substance leaving the user restricted to a predetermined scent confined to the area made available to contain said scent.

U.S. Pat. No. 4,790,307 to Haber et al. (1988) depicts a surgical mask manufactured with a scent mechanism embedded within the material. It has limited scent options and is disposable.

U.S. Pat. No. 5,243,708 to Vaunch (1993) provides a disposable, pre-scented mask that is held to the wearer's face by way of clenching the mask in the teeth or mouth. This idea prevents the user from communicating freely and is limited to a selection of scents predetermined before manufacturing.

U.S. Pat. No. 5,538,013 to Brannon (1996) is also disposable and restricted to predefined, exclusive, pocket-shaped scented cartridge inserts.

U.S. Pat. No. 7,004,167 to Cheng (2006) is similar to Harber et al. Patent where a close fitting surgical style mask is pre-scented with an aromatic capsule.

U.S. Pat. No. 7,311,105 to Plummer, Jr. et al. (2007) uses a device similar to a smelling salt to release a scent upon demand and is intended to be disposable and is also restricted to a predefined scent selection.

All of these previous inventions had one thing in common; they are all designed to be short term solutions and they all require the user to either purchase an additional proprietary scent emitting item or they already have one embedded in them. The face mask disclosed herein, however, is designed to withstand use over the course of multiple applications thereby reducing waste and moreover contains a pliable restraining fastener capable of binding a variety of scent releasing options to customize one's fragrant reprieve.

The mask's base is constructed of a woven cloth or paper or paper-cloth combination and generally bowl shaped. The outside of the mask, or the side of the mask that faces away from the wearer, is decorated using a variety of craft materials to mimic anything found to be engaging or entertaining to an intended observer. The inside of the mask, or the side of the mask that covers the user's nose and mouth, contains a pliable retention device that allows the user to customize a variety of redolent options. These options include, but are not limited to; a scent strip as found in cardboard air fresheners, spices held together in a permeable material, scent-saturated cloth or cotton, etc. The mask is held in place with an elastic strap and the user is free to communicate verbally.

In this embodiment, the retention device that holds the scent in place consists of a pliable fastener similar to that found in garbage bag twist ties affixed to the inside of the mask at nostril level and in such a fashion so that the user can place their selected scent on top of said fastener and fold the pliable material over the scent to hold the scent in place.

The specific area of use for this mask that seems most fitting would be in changing a child's diaper where the user is provided a practical barrier for breathing relief while the child sees a funny face to engage their attention in an amusing manner. Other areas of use could include any situation where someone seeks to avoid experiencing unpleasant odors and wishes to customize their own olfactory saturation.

### SUMMARY

In accordance with one embodiment a mask designed to entertain an observer while providing the user a means by which to secure their own scented object or selection of scented objects.

### DRAWINGS

### Figures

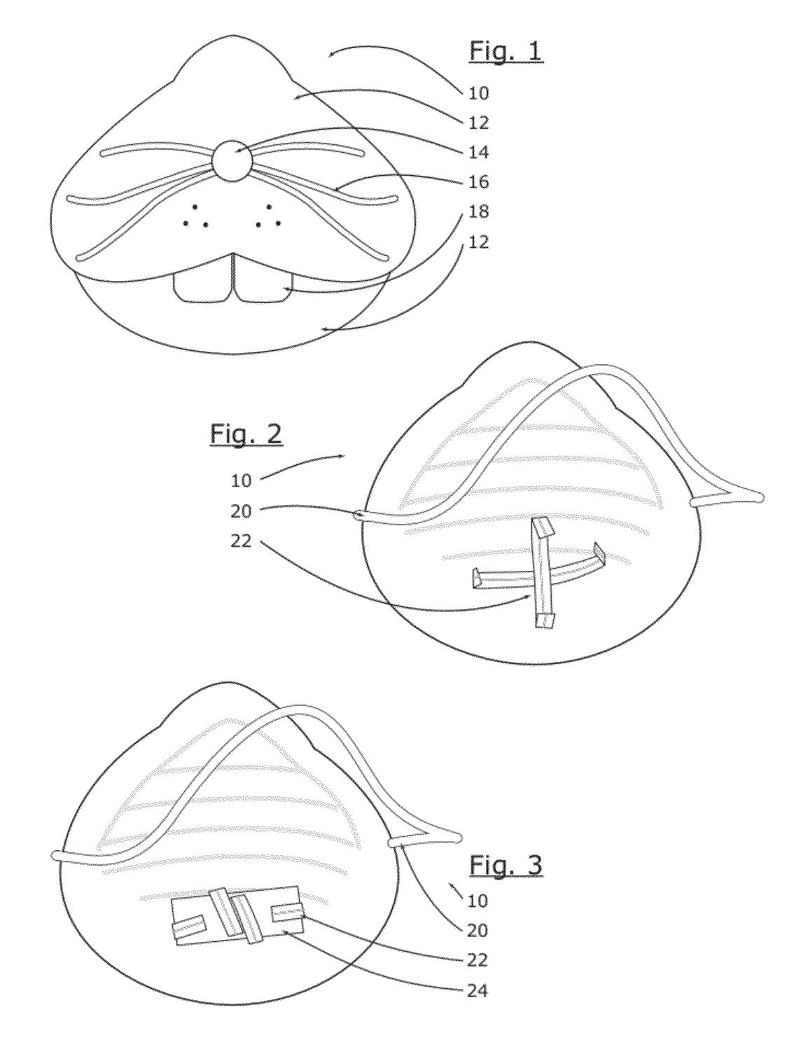

FIG. 1 shows one depiction of the outside front of a decorated mask.

FIG. 2 shows the inside back of the mask with the scent retention device empty.

FIG. 3 shows the inside back of the mask with the scent retention device holding a rectangular scent strip.

DRAWINGS - Reference Numerals

10 Mask
12 Felt material to simulate fur
14 Pon Pon to simulate nose
16 Craftlace to simulate whiskers
18 Peel & stick foam to simulate teeth
20 Elastic strap
22 Pliable wire
24 Scent strip

### DETAILED DESCRIPTION

### FIG. 1—First Embodiment

One embodiment of the outward appearance of the mask is illustrated in FIG. 1 (front view). The depiction rendered is that of a rabbit or mouse nose and mouth and is intended to simulate a character that a child might find amusing. The base material 12 is affixed to a household dust/nuisance mask 10 with spray adhesive. The other components 14, 16 and 18 are held in place with hot melt adhesive.

### FIGS. 2-3—Rear View

A strap 20 holds the mask to the wearer's face.

Pliable fasteners 22 are affixed to the inside of the mask with hot melt adhesive at a point that leaves enough pliable fastener free to secure a variety of shaped and sized aromatic preferences.

### Advantages

From the description above a clear advantage of my embodiment of a flexible scent-restraining containment mask becomes evident:
1. The use of a flexible retention device allows this mask to accommodate a variety of customizable options allowing the user to select the scented object or objects at their discretion.

I claim:

1. A mask placeable over respiratory organ of a user's face for blocking out unpleasant odors and containing a flexible scent-restraining device, said mask comprising:
an air-permeable body having an inner surface, said inner surface having a profile which is shaped to fit over the respiratory organ of the user;
a strap extending from opposite sides of said mask for securing said mask over the respiratory organ of the user; and
an arrangement of pliable material affixed to inner surface of said mask at nostril level for fastening a scent emitting object.

2. The mask as described in claim 1, wherein said arrangement of pliable material affixed to inner surface of mask further comprising:
a cross configuration of wire affixed at a central point of said wire to the inner surface of said mask at nostril level; and
a section of said wire not directly affixed to inner surface of said mask left free for purpose of grasping an object placed on top of said wire.

3. The mask as described in claim 1, wherein said arrangement of pliable material affixed to inner surface of mask further comprising:
a cross configuration of pliable material affixed at a central point of said pliable material to the inner surface of said mask at nostril level; and
a section of said pliable material not directly affixed to inner surface of said mask left free for purpose of grasping an object placed on top of said pliable material.
